(19) United States
(12) Patent Application Publication
(10) Pub. No.: US 2008/0140348 A1
(43) Pub. Date: Jun. 12, 2008

(54) SYSTEMS AND METHODS FOR PREDICTIVE MODELS USING GEOGRAPHIC TEXT SEARCH

(75) Inventor: John R. FRANK, Cambridge, MA (US)

Correspondence Address: WILMERHALE/BOSTON, 60 STATE STREET, BOSTON, MA, 02109, US

(73) Assignee: METACARTA, INC., Cambridge, MA (US)

(21) Appl. No.: 11/932,438

(22) Filed: Oct. 31, 2007

Related U.S. Application Data
(60) Provisional application No. 60/855,669, filed on Oct. 31, 2006.

(51) Int. Cl. G06F 17/18

(52) U.S. Cl. 702/181; 702/179

(57) ABSTRACT

Under one aspect, a computer-implemented method of generating a predictive model includes accepting search criteria from a user, the search criteria including information identifying a past event, a domain identifier identifying a domain in which the past event occurred, and a time identifier identifying a time period preceding the past event; obtaining a plurality of sets of document-location-time tuples based on the domain identifier and the time identifier; statistically analyzing the sets of document-location-time tuples; comparing results of the statistical analysis of the sets of document-location-time tuples to identify information that precedes and statistically correlates with the past event; and displaying information associated with the identified information on a display device.

### CROSS REFERENCE TO RELATED APPLICATIONS

This application claims the benefit under 35 U.S.C. §119(e) of U.S. Provisional Application No. 60/855,669, filed Oct. 31, 2006 and entitled “Predictive Models Based on Geographic Text Search,” the entire contents of which are incorporated herein by reference.

### TECHNICAL FIELD

This invention relates to computer systems, and more particularly to spatial databases, document databases, search engines, and data visualization.

### BACKGROUND

There are many tools available for organizing and accessing documents through different interfaces that help users find information. Some of these tools allow users to search for documents matching specific criteria, such as containing specified keywords. Some of these tools present information about geographic regions or spatial domains, such as driving directions presented on a map.

These tools are available on private computer systems and are sometimes made available over public networks, such as the Internet. Users can use these tools to gather information.

### SUMMARY OF THE INVENTION

Embodiments of the invention provide systems and methods for predictive models based on geographic text search.

Under one aspect, a computer-implemented method of generating a predictive model includes accepting search criteria from a user, the search criteria including information identifying a past event, a domain identifier identifying a domain in which the past event occurred, and a time identifier identifying a time period preceding the past event; obtaining a plurality of sets of document-location-time tuples based on the domain identifier and the time identifier; statistically analyzing the sets of document-location-time tuples; comparing results of the statistical analysis of the sets of document-location-time tuples to identify information that precedes and statistically correlates with the past event; and displaying information associated with the identified information on a display device.

Some embodiments include one or more of the following features. Labeling the identified information according to an event type, and storing the labeled identified information on a computer-readable medium. Obtaining the plurality of sets of document-location-time tuples includes obtaining a first set of tuples that includes information about the domain, and obtaining a second set of tuples that includes information about a region that excludes the domain. Obtaining a plurality of sets of document-location-time tuples includes obtaining a first set of tuples that includes information about a time period preceding the past event, and obtaining a second set of tuples that includes information about a time period that excludes the time period preceding the past event. Automatically refining the identified information based on at least some document-location-time tuples in response to user input. Said refining includes at least one of accepting user input scoring at least some of the document-location-time tuples and entering a feedback loop; accepting user input truthing at least some of the document-location-time tuples and entering a feedback loop; using blind relevance feedback in response to a user instruction; and accepting user input modifying the identified information. The information associated with the identified information includes a model of an event of the same type as the past event. The information associated with the identified information includes an abstraction of the identified information. The identified information includes at least one of a statistically interesting phrase and statistically interesting information.

Under another aspect, an interface program stored on a computer-readable medium causes a computer system with a display device to perform the functions of accepting search criteria from a user, the search criteria including information identifying a past event, a domain identifier identifying a domain in which the past event occurred, and a time identifier identifying a time period preceding the past event; obtaining a plurality of sets of document-location-time tuples based on the domain identifier and the time identifier; statistically analyzing the sets of document-location-time tuples; comparing results of the statistical analysis of the sets of document-location-time tuples to identify information that precedes and statistically correlates with the past event; and displaying information associated with the identified information on a display device.

Some embodiments include one or more of the following features. The program further causes the computer system to perform the functions of labeling the identified information according to an event type, and storing the labeled identified information on a computer-readable medium. Obtaining the plurality of sets of document-location-time tuples includes obtaining a first set of tuples that includes information about the domain, and obtaining a second set of tuples that includes information about a region that excludes the domain. Obtaining a plurality of sets of document-location-time tuples includes obtaining a first set of tuples that includes information about a time period preceding the past event, and obtaining a second set of tuples that includes information about a time period that excludes the time period preceding the past event. The program further causes the computer system to perform the functions of automatically refining the identified information based on at least some document-location-time tuples in response to user input. Said refining includes at least one of accepting user input scoring at least some of the document-location-time tuples and entering a feedback loop; accepting user input truthing at least some of the document-location-time tuples and entering a feedback loop; using blind relevance feedback in response to a user instruction; and accepting user input modifying the identified information. The information associated with the identified information includes a model of an event of the same type as the past event. The information associated with the identified information includes an abstraction of the identified information. The identified information includes at least one of a statistically interesting phrase and statistically interesting information.

Under another aspect, a computer-implemented method of using a model to predict an event includes accepting search criteria from a user, the search criteria including information identifying a type of event the user would like to predict, a domain identifier identifying a domain, and a time identifier identifying a time period; obtaining a model based on the type of event the user would like to predict, the model including information that was previously identified as being predictive of the type of event; obtaining a set of document-location-time tuples based on the domain identifier and the time identifier, each of the document-location-time tuples including at least some of the information that was previously identified as being predictive of the type of event; based on the set of document-location-time tuples, estimating a probability that the type of event will occur in the domain; and if the estimate of the probability exceeds a predefined threshold, alerting the user.

Some embodiments include one or more of the following features. Alerting the user includes at least one of displaying information about the estimated probability of the event to the user; emailing a notification to the user; displaying a visual representation of the domain identified by the domain identifier; and displaying at least one of the document-location-time-tuples to the user. Providing an interface allowing a user to request additional information related to the estimate of the probability. The request for additional information includes a free text query string, and wherein the method further includes displaying to the user a visual representation of locations identified in document-location-time tuples responsive to the free text query. The request for additional information includes a spatial domain identifier identifying a domain, and wherein the method further includes displaying to the user a visual representation of the identified domain and a listing of documents containing spatial identifiers that identify locations within the domain. Providing an interface for the user to modify the model. The interface allows the user to provide a set of training document-location-time tuples that include information about the type of event.

Under another aspect, an interface program stored on a computer-readable medium causes a computer system with a display device to perform the functions of accepting search criteria from a user, the search criteria including information identifying a type of event the user would like to predict, a domain identifier identifying a domain, and a time identifier identifying a time period; obtaining a model based on the type of event the user would like to predict, the model including information that was previously identified as being predictive of the type of event; obtaining a set of document-location-time tuples based on the domain identifier and the time identifier, each of the document-location-time tuples including at least some of the information that was previously identified as being predictive of the type of event; based on the set of document-location-time tuples, estimating a probability that the type of event will occur in the domain; and if the estimate of the probability exceeds a predefined threshold, alerting the user on a display device.

Some embodiments include one or more of the following features. Alerting the user includes at least one of displaying information about the estimated probability of the event to the user on the display device; emailing a notification to the user; displaying a visual representation of the domain identified by the domain identifier on the display device; and displaying at least one of the document-location-time-tuples to the user on the display device. The program further causes the computer system to perform the functions of providing an interface allowing a user to request additional information related to the estimate of the probability. The request for additional information includes a free text query string, and wherein the program further causes the computer system to perform the functions of displaying to the user a visual representation of locations identified in document-location-time tuples responsive to the free text query. The request for additional information includes a spatial domain identifier identifying a domain, and wherein the program further causes the computer system to perform the functions of displaying to the user a visual representation of the identified domain and a listing of documents containing spatial identifiers that identify locations within the domain. The program further causes the computer system to perform the functions of providing an interface for the user to modify the model. The interface allows the user to provide a set of training document-location-time tuples that include information about the type of event.

The details of one or more embodiments of the invention are set forth in the accompanying drawings and the description below. Other features, objects, and advantages of the invention will be apparent from the description and drawings, and from the claims.

### DESCRIPTION OF DRAWINGS

In the Drawing:

FIG. 1 schematically shows an overall arrangement of a computer system according to some embodiments of the invention.

FIG. 2 schematically represents an arrangement of controls on a map interface according to some embodiments of the invention.

FIG. 3 is a schematic of steps in a method of training a predictive model based on geographic text search according to some embodiments of the invention.

FIG. 4 is a schematic of steps in a method of using a predictive model based on geographic text search according to some embodiments of the invention.

### DETAILED DESCRIPTION

### Overview

Embodiments of the invention provide predictive models based on geographic text search. A predictive model uses a geographic text search (GTS) engine to automatically analyze documents that contain precursor information about a known past event, e.g., documents that were generated before the past event, but which, in retrospect, contain information that indicated or suggested that the event was going to occur. This information includes words and/or phrases that statistically correlate to the occurrence of the event, although a human reading the words or phrases might not readily recognize some or all of the correlations. The predictive model then uses this information to analyze other documents that might contain precursor information about a future event, e.g., to determine whether these other documents include the words and/or phrases that statistically correlate to the occurrence of the event, to attempt to predict whether a similar event will occur in the future. If the predictive model detects that the other documents do contain such precursor information, then the model alerts a user that a similar event may occur. Thus, the models can be used in two different modes: a “training mode” in which the model is developed and enhanced using past events, and a “predicting mode” in which the model is used to attempt to predict events.

When the system alerts the user that an event may occur, it can show the user documents supporting the model's prediction and can suggest new GTS searches that might help the user assess the problem. These new GTS searches typically involve a domain associated with the prediction and possibly keywords or topics or categories of information relevant to the prediction. For example, a model might be trained to recognize precursors to bankruptcies in companies in developing countries. When such a model detects precursors in documents that newly become available to the system, these new documents will generally contain spatial location identifiers that allow the model to anticipate a building housing company at risk of bankruptcy The alert generated by a system running such a model would then alert one or more users by sending the a visual representation of the anticipated domain, e.g. a map showing the location of the company at risk, and also documents containing information that triggered the alert. The system may suggest further GTS searches to get the alerted users started in researching the possible risk.

To use a different example, a model might be quite broad and identify possible ship docking events. Since ships dock in harbors very frequently, such a model might predict new events thousands of times each day. When training such a model, the user might have to carefully examine documents that triggered false alarms and pass some of these documents back into the model for further training. Such an iterative training process allows human users to refine the type of alerts generated by the system. When a new model is first created, it might generate a huge fraction of erroneous alerts. The user can then improve this situation by training the system to ignore information that is deemed uninteresting by the user and to identify information that is deemed interesting. As the user refines the training data available to the model, the alerts will generally become higher precision and higher recall—recall and precision are terms of art that mean the fraction of false positives and fraction of missed identifications, respectively. As the world changes, the model's performance may change. New types of information may begin appearing in news reports or other streams of documents available to the system, and thus the precision and recall may go down (or up) over time. When this happens, users can re-train the model by providing new examples of useful and anti-useful information.

As a further example, a researcher might train a model to anticipate changes in social behavior such as slash and burn agriculture in the Amazon rainforest. Documents describing this social behaviors and precursor information come from news reports, on-the-ground interviews, weather data, satellite images showing foliage cover, and other information. As these pieces of data enter the GTS, the user issues queries to find areas and time periods of interest. Since most of the information has both spatial and temporal identifiers, the user can filter the massive amounts of information using both spatial ranges and temporal ranges. When the user finds information the describes the lead up to an event, such as clearing a large area of primal forest, the user can submit this information to the system to establish or refine a predictive model. This model then attempts to recognize similar “lead up” precursors to similar events. Some of these events may have already transpired. The user can study these past events and submit them to the system to further refine the model. If some of the anticipated events are of the wrong type, the user can indicate to the system that these are false positives. For anticipated events that have not yet transpired, the user can study the precursor information provided by the system. Such study typically involves examining the information in more detail by issuing queries to obtain more information. The predictive model can be used to suggest queries to the user, to accelerate their researching the topic. In some situations, the user may decide to take action, such as sending people to attempt to protect the forest form impending damage from slash & burn farmers. Often, the system generates many alerts and the user must maintain a constant cycle of refining the model, generating separate models for different types of predictions, and assessing warnings predicted by the models.

One use of predictive models based on GTS is to help users find new information. Instead of simply waiting for users to try new queries, predictive models can generate queries for users and look for interesting results. When a model determines that a set of results is interesting, it alerts the user to look at these results.

While a predictive model can be used with a conventional text search engine, using a predictive model with a GTS engine provides a particularly powerful way of obtaining information from documents about actual events, because events are almost always associated with a particular geographic domain (e.g., a city, county, country, or even globally). However, even though a particular document may include information about a particular location within a domain (e.g., New York City), the document itself may not include the name of the domain of interest (e.g., United States). Therefore, a keyword search executed using the domain of interest as a keyword would likely not find the document, and the user would not obtain the information within that document. Indeed, in order to obtain as many documents as possible that refer to locations within the domain of interest, a user using only a keyword search would have to construct a very large number of keyword searches, each having different permutations of location names, to find documents. This would be burdensome on the user, and would also be computationally intensive. In comparison, a GTS engine allows a user to merely identify the particular domain of interest in order to obtain documents that reference locations within that domain. This capability is enabled, in part, by a computer system that obtains location-related information about the document, as well as time-related information, and “tags” the document with metadata about that location and time, generating a “document-location-time tuple,” which is described in greater detail below.

First, a brief overview of an exemplary GTS system that includes a predictive model subsystem, and a graphic user interface (GUI) running thereon, will be described. Then, the predictive model subsystem will be described in greater detail.

One example of a geographic text search (GTS) engine is described in U.S. Pat. No. 7,117,199, the entire contents of which are incorporated herein by reference. The GTS engine enables a user, among other things, to pose a query via a map interface and/or a free-text query. The query results returned by the GTS engine are represented on a map interface as visual indicators, such as icons. The map and the indicators are responsive to further user actions, including changes to the scope of the map, changes to the terms of the query, or closer examination of a subset of results.

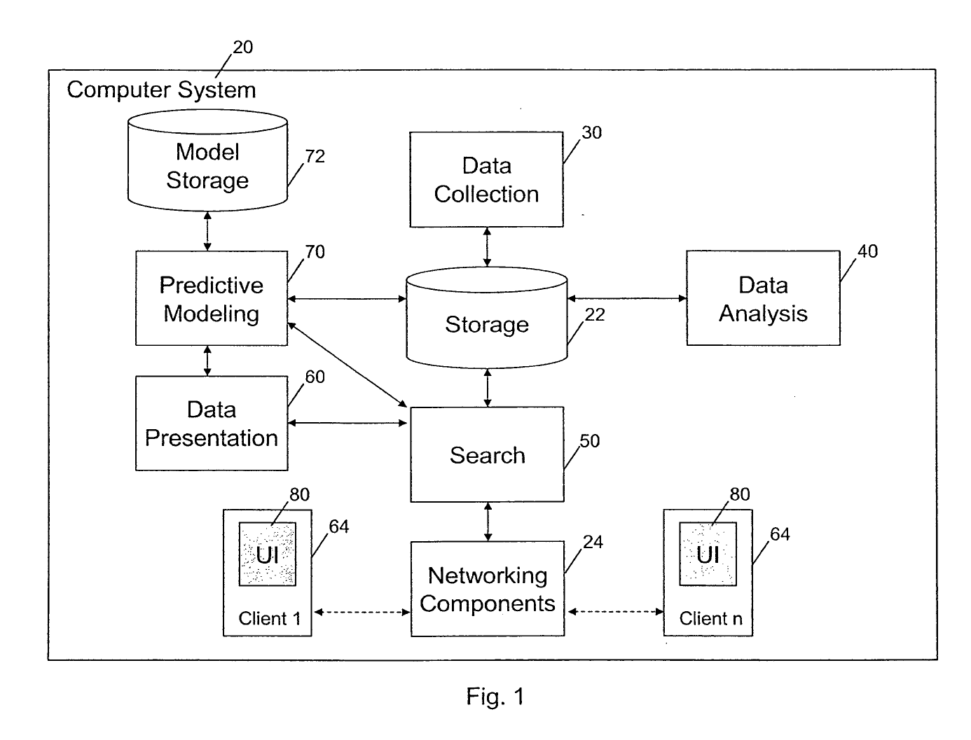

In general, with reference to FIG. 1, the GTS engine computer system 20 includes a storage 22 system which contains information in the form of documents, along with location-related information about the documents. The computer system 20 also includes subsystems for data collection 30, automatic data analysis 40, search 50, data presentation 60, and predictive modeling 70. The computer system 20 further includes networking components 24 that allow a user interface 80 to be presented to a user through a client 64 (there can be many of these, so that many users can access the system), which allows the user to execute searches of documents in storage 22, and represents the query results arranged on a map, in addition to other information provided by one or more other subsystems, as described in greater detail below. The system can also include other subsystems not shown in FIG. 1.

The data collection 30 subsystem gathers new documents, as described in U.S. Pat. No. 7,117,199. The data collection 30 subsystem includes a crawler, a page queue, and a metasearcher. Briefly, the crawler loads a document over a network, saves it to storage 22, and scans it for hyperlinks. By repeatedly following these hyperlinks, much of a networked system of documents can be discovered and saved to storage 22. The page queue stores document addresses in a database table. The metasearcher performs additional crawling functions. Not all embodiments need include all aspects of data collection subsystem 30. For example, if the corpus of documents to be the target of user queries is saved locally or remotely in storage 22, then data collection subsystem need not include the crawler since the documents need not be discovered but are rather simply provided to the system.

In addition, the data collection 30 subsystem may include a connector framework that allows the GTS to obtain documents from a variety of other document systems. For example, the connector framework may allow the GTS to retrieve documents stored in an Oracle database globs or stored in a Livelink document repository. The connector framework may allow the GTS to obtain documents from a flat file system, such as Windows Shared Drives, which often contain a variety of structured and unstructured data files. These files (which we refer to generally as documents) may contain spatial information. For example, CAD diagrams of buildings or equipment may contain spatial coordinates or reference points. Similarly, ESRI shapefiles and Google Earth KML files may contain geographic coordinates. When the GTS retrieves documents from such file systems (via the connector framework), it scans the contents of the files to identify spatial, temporal, and other information.

A document is any file that can be saved on computer readable media. Accessing information in documents is usefully distinguished from the standard method of accessing information in database records, in that at least some of the information in a document is not typed by the mechanism used to access the document. As is standard in the art, when accessing a database record, the software interfacing with the database treats the various fields (or “columns”) in the record as having defined types, such as “varchar” for a string of characters of variable length or “timestamp” or “coordinate.” These properties of the data in the database allow the database to offer a “typed interface” to other programs. This typed interface ensures that the other programs can rely on the definition of the type of information coming out of the database. In contrast, when accessing information stored in documents, at least some of the information is not yet accessible via such a typed interface. Instead, the system analyzes the contents of the documents to assess what the type of various portions of the contents might be. For example, the system analyzing a document may conclude that the text string “two miles east of Al Hamra” might a location reference.

The data analysis 40 subsystem extracts information and meta-information from documents. As described in U.S. Pat. No. 7,117,199, the data analysis 40 subsystem includes, among other things, a spatial recognizer and a spatial coder. As new documents are saved into storage 22, the spatial recognizer opens each document and scans the content, searching for patterns that resemble parts of spatial identifiers, i.e., that appear to include information about locations. One exemplary pattern is a street address. Another exemplary patterns are relative references, like “two miles east of Al Hamra,” and spatial coordinates, like MGRS coordinates such as “36SWF2248402617,” Universal Transverse Mercator (UTM) coordinates such as “357973N527260E ZONE 38” and unprojected latitude-longitude coordinates such as “3°14′19″N45°14′43″E”. The spatial recognizer then parses the text of the candidate spatial data, compares it to known spatial date, and computes numerical scores describing the association between the document and the location. These confidence and relevance score is typically combined with other scoring factors to compute the total relevance score describing the degree of match between a document-location tuple (or a portion of a document and a location) to a particular query issued to the GTS system. Results returned by the GTS system are ranked by such a total relevance score. Some documents can have multiple spatial references, in which case each reference is treated separately. The spatial coder then associates domain locations with various identifiers in the document content. The spatial coder determines coordinates in a common coordinate system, such as unprojected latitude-longitude with the WGS84 datum. The numerical scores include both confidence scores, describing the probability that the creator of the document intended to refer to the determined location, and also relevance scores indicating how much of the document's attention is dedicated to a particular location or region enclosing several locations. The spatial coder can also deduce associations between specific text strings and domain locations that are not recorded by any existing geocoding services, e.g., infer that the “big apple” frequently refers to New York City. Such deduced associations are characterized by confidence scores that indicate how likely it is that authors intend that associated location when they write a specific text string. The identified location-related content associated with a document may in some circumstances be referred to as a “GeoTag.”

Data analysis subsystem 40 also obtains time-related information for the documents. For example, a document was normally generated on a given date, and may also contain information about other time periods, eras, or dates. As described in greater detail below, some or all of this time information can be used to select documents that are relevant to a particular event, because events normally occur within an identifiable time frame. To analyze a document for temporal references, a standard approach in the art is to use a regular expression pattern matching tool that looks for strings of text that are known to refer to periods of time, such as “June” “January” “1999” “twelve minutes to noon” “Christmas” “the Ordovician” and “before the Revolutionary War.” Some such strings are unambiguously temporal, e.g. the Ordovician almost always has a temporal connotation even when used as an adjective. Other strings, like “June” have common non-temporal meanings. After identifying such phrases uses a regular expression tool, the data analysis subsystem 40 assesses the surrounding context to determine whether it confirms a temporal interpretation of the string. For example, if the word “June” is used in a sentence with a personal action verb immediately following it, such as “June ate a peach,” then the system computes a low confidence score that this reference is to the month of June. On the other hand, if it appears in a pattern such as “Jun. 8, 1993” the system can generate a high confidence score that the author meant a time, and in this case it is easy to associate the string with a widely accepted time standard, such as seconds since the common epoch (Jan. 1, 1970 00:00:01 UTC). In this case, the first second of Jun. 8, 1993 was 739558800 seconds since the epoch. Of course, the author could have meant a different second within that day, so the system might associate a time range with any given time reference to indicate the degree of precision that it believes the author intended. In this case, the system might give the middle second of that day and indicate a possible error of plus or minus half of a day. Similarly, the Ordovician was a very long time period, and the system would associate a wide range of possible times associated with it. In the case of the Ordovician, the times are all before the common epoch, i.e. measured in negative seconds. Similarly to the location extraction and disambiguation process, the time extraction and disambiguation process can assign both confidence scores and relevance scores and other numerical scores describing the association between the document's contents and the identified time period.

In general, confidence scores indicate how likely it is that the author intended a particular string of text to have a particular meaning. In general, document-entity relevance scores indicate how much of the text's attention is paid to a particular entity (i.e. meaning). In general, query relevance scores indicate how likely it is that a search user or non-human query issuer will find a particular set of text strings interesting.

Documents, location-related information identified within the documents, and time-related information are saved in storage 22 as “document-location-time tuples,” which are three-item sets of information containing a reference to a document (also known as an “address” for the document) and a metadata that includes a domain identifier identifying a location and a time identifier identifying a time associated with the document. The metadata may also include the coordinates of the location, the character range in the document that includes the location-related information, and/or the part of the document in which the location-related information can be found (e.g., the title, body, footnote), which information may be relevant to how prominent the information is within the document. Storage 22 may be considered a “corpus of documents.” A “corpus of documents” is a collection of one or more documents. Typically, a corpus of documents is grouped together by a process or some human-chosen convention, such as a web crawler gathering documents from a set of web sites and grouping them together into a set of documents; such a set is a corpus. The plural of corpus is corpora.

The search 50 subsystem responds to queries with a set of documents ranked by relevance. The set of documents that satisfy both the free-text query and the spatial criteria submitted by the user (or another computer-implemented system capable of issuing queries) are passed to the data presentation 60 subsystem.

The data presentation 60 subsystem manages the presentation of information to the user as the user issues queries or uses other tools on UI 80. For example, given the potentially vast amount of information, document ranking is useful. If results relevant to the user's query were overwhelmed by irrelevant results, the system may be effectively useless to the user. The data presentation 60 subsystem can organize search results based on various criteria, for example based on the various numerical scores, including relevance scores, of the document-location-time tuples obtained during the query.

The predictive modeling subsystem 70 analyzes documents in storage 22 to determine the statistical correlation of words and/or phrases in documents with past events, and to attempt to predict future events by identifying the same or similar words and/or phrases in other documents, as described in greater detail below. The predictive modeling subsystem stores models in model storage 72, e.g., after generating the model using past events, and also obtains models from model storage 72, e.g., for use in predicting future events.

Note that the configuration of the system can be different. For example, a predictive model system could include a GTS subsystem. Or, for example, a predictive model system could interface with an external GTS system.

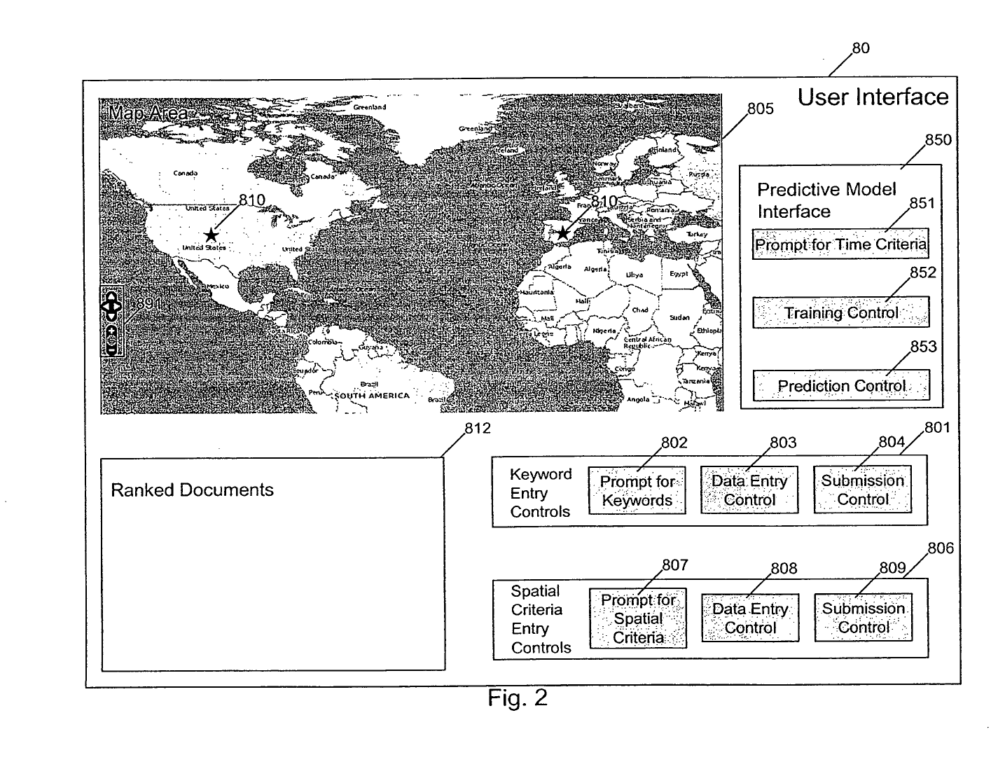

With reference to FIG. 2, the user interface (UI) 80 is presented to the user on a computing device having an appropriate output device. The UI 80 includes multiple regions for presenting different kinds of information to the user, and accepting different kinds of input from the user. Among other things, the UI 80 includes a keyword entry control area 801, an optional spatial criteria entry control area 806, a map area 805, a document area 812, and a predictive model interface 850 that the user can use to interact with the predictive modeling subsystem.

As is common in the art, the UI 80 includes a pointer symbol responsive to the user's manipulation and “clicking” of a pointing device such as a mouse, and is superimposed on the UI 80 contents. In combination with the keyboard, the user can interact with different features of the UI in order to, for example, execute searches, inspect results, or correct results, as described in greater detail below.

Map 805 represents a spatial domain, but need not be a physical domain. The map 805 uses a scale in representing the domain. The scale indicates what subset of the domain will be displayed in the map 805. The user can adjust the view displayed by the map 805 in several ways, for example by clicking on the view bar 891 to adjust the scale or pan the view of the map.

A “domain” is an arbitrary subset of a metric space. Examples of domains include a line segment in a metric space, a polygon in a metric vector space, and a non-connected set of points and polygons in a metric vector space. A “spatial domain” is a domain in a metric vector space. A “physical domain” is a spatial domain that has a one-to-one and onto association with locations in the physical world in which people could exist. For example, a physical domain could be a subset of points within a vector space that describes the positions of objects in a building. An example of a spatial domain that is not a physical domain is a subset of points within a vector space that describes the positions of genes along a strand of DNA that is frequently observed in a particular species. Such an abstract spatial domain can be described by a map image using a distance metric that counts the DNA base pairs between the genes. An abstract space, humans could not exist in this space, so it is not a physical domain. A “geographic domain” is a physical domain associated with the planet Earth. For example, a map image of the London subway system depicts a geographic domain, and a CAD diagram of wall outlets in a building on Earth is a geographic domain. Traditional geographic map images, such as those drawn by Magellan depict geographic domains.

The traditional definition of a spacetime “event” is suitable for our purposes. In the language of classical physics, space is three-dimensional vector space with locations identifiable by triplets of numerical distances measured relative to a chosen reference frame. Material objects and energy are present in various forms in space; this includes humans, Earth, and everything on it. Time is a one one-dimensional continuum indexing configurations of objects and energy in space. Times can be identified by numerical distances measured relative to a chosen reference point. A spacetime point is a quadruplet of numerical distances including a space triplet and a time. Another name for a spacetime point is an “event.” While people typically associate many anthropogenic details with events, any moment in space and time counts as an event. Of course, not all events are interesting. Those events with particular anthropogenic details are usually what people wish to understand and anticipate. The software system described here utilizes these additional details about particular events to train a model that analyzes documents to anticipate similar events.

The user identifies an event (past or future) of interest using the keyword entry controls 801, and identifies the domain of the event using the spatial criteria entry controls 806 and/or the map 805. As described in U.S. Pat. No. 7,117,199, keyword entry control area 801 and optional spatial criteria control area 806 allow the user to execute queries based on free text strings as well as spatial domain identifiers (e.g., geographical domains of particular interest to the user). The spatial domain identifier might be a string of text identifying a domain, or a bounding box or polygon (or polyhedron) selected from a multi-dimensional visual representation of a larger domain containing the domain of interest, or an item selected from a listing or visually organized hierarchy of domain identifiers. Generally, a “domain identifier” is any suitable mechanism for specifying a domain. For example, a list of points forming a bounding box or a polygon is a type of domain identifier. A map image is another type of domain identifier.

Keyword entry control area 801 includes areas prompting the user for entry of a keyword a more complex free text query 802, data entry control 803, and submission control 804. Examples of keywords include any word of interest to the user, or simply a string pattern. A “free text query” is a query based on a free text string input by a user. While a free text query be used as an exact filter on a corpus of documents, it is common to break the string of the free text query into multiple substrings that are matched against the strings of text in the documents. For example, if the user's query is “car bombs” a document that mentions both (“car” and “bombs”) or both (“automobile” and “bomb”) can be said to be responsive to the user's query. The textual proximity of the words in the document may influence the relevance score assigned to the document. Removing the letter “s” at the end of “bombs” to make a root word “bomb” is called stemming.

Spatial criteria entry control area 806 includes areas prompting the user for spatial criteria 807, data entry control 808, and submission control 809. The user can also use map 805 as a way of entering spatial criteria by zooming and/or panning to a domain of particular interest, i.e., the extent of the map 805 is also a form of domain identifier. This information can be transmitted as a bounding box defining the extreme values of coordinates displayed in the map, such as minimum latitude and longitude and maximum latitude and longitude. For example, if the user is interested in determining whether a H5n1 flu outbreak is likely to happen in Indonesia the future, the user enters the string “H5n1” using the keyword entry controls 801, and identify the domain of Indonesia by either zooming to an image of Indonesia in map 805 or by entering “Indonesia” in the spatial criteria entry controls 806.

The predictive model interface 850 includes a prompt for time criteria 851, a training control 852 and a predicting control 853. The prompt for time criteria 851 allows the user to define a date range of interest to the event, e.g., a specified date range prior to a past event of interest, or a specified amount of time before the current date. The training control 851 allows the user to instruct the predictive modeling subsystem to analyze documents that contain information about the known past event, and to identify words and/or phrases that statistically correlate to the event, i.e., to “train” the model. The predicting control 852 allows the user to instruct the predictive modeling subsystem to analyze documents that might contain information about future events, e.g., to search for words and/or phrases that the subsystem previously identified as being correlated to a past event, and that therefore represent the possibility that a similar event will occur in the future.

The computer system 20 identifies documents from the corpus of documents (e.g., storage 22) that are associated with temporal periods that satisfy the time criteria, are associated with text that satisfies the free text query and/or that are associated with the event identified in the query text, and are associated with domain locations that satisfy the location search criteria. The system then analyzes the identified documents to identify words and/or phrases that have a statistical correlation with an event of interest.

After the computer system identifies documents and words and/or phrases within those documents, the map interface 80 may use visual indicators 810 to represent at least a subset of those documents, e.g., documents that satisfy the criteria to a predetermined extent. The display placement of a visual indicator 810 (e.g., an icon) represents a correlation between a document and the corresponding domain location. Specifically, for a given visual indicator 810 having a domain location, and for each document associated with the visual indicator 810, the subsystem for data analysis 20 determined that the document relates to the domain location. The subsystem for data analysis 20 might determine such a relation from a user's inputting that location for the document. Note that a document can relate to more than one domain location, and thus can be represented by more than one visual indicator 810. Conversely, a given visual indicator can represent many documents that refer to the indicated location.

If present, the document area 812 displays a list of documents or document summaries or portions of documents to the user.

The predicting control 852 optionally includes a control (not shown) that allows the user to instruct the predictive modeling subsystem to continuously or periodically analyze documents that might contain information about a future event, e.g., as new documents become available, and to notify the user if information in the documents suggests the event will occur. This allows the user to continue to monitor for indicators that the event will occur.

### Predictive Model

A trainable predictive model (TPM) based on GTS can be used to automatically anticipate future events based on patterns of precursor information within documents. Many types of documents include precursor information, but the precursor information may not be apparent to a human reader. This precursor information can include, among other things, strings of text that are statistically correlated with events of that type (e.g., particular phrases, numbers), the fact that a document exists (e.g., a record of a hospital admission), a characteristic of a document (e.g., the presence of a picture with text). The precursor information, on its face, might not appear to indicate the occurrence of the event; for example, a hospital admission would not necessarily suggest that an Ebola outbreak was beginning. However, a sharp uptake in hospital admissions, e.g., as compared to a normal “background” level of hospital admissions, could suggest that an outbreak of some type (e.g., disease, violence) was occurring, and could be used with other information to determine the type of outbreak.

As noted above, TPMs interface with a body of information, e.g., a corpus of documents that might include precursor information about one or more events (past or future). Generally, the more information is available to the TPM, the better chance that the TPM will identify precursor information. The corpus of documents can come from many different sources. For identifying some particular types of events, e.g., disease outbreaks, an interface with a particular corpus of documents, e.g., hospital records, will be useful. Useful sources of precursor information can include unstructured news articles, web pages, police records, hospital records, stock exchange information (such as a tickertape), statistical data, image databases, emails, transcribed verbal information (such as conversations), broadcast news, scanned documents, message traffic, etc.

TPMs can be used by the computer system in two modes: “training” and “prediction.” The system includes an interface such as interface 852 in FIG. 2 that allows the user to instruct the system to enter training mode. In this mode, the system identifies precursor information within a set of documents, such as words and/or phrases that are statistically correlated with, and precede, a past event. The system then generates a statistical model (the TPM) from this precursor information, which it stores on a computer-readable medium for use in predicting future events.

The system also includes an interface such as interface 853 in FIG. 2 that allows the user to instruct the system to enter prediction mode, in which the system uses the TPM stored during training mode to analyze another set of documents that might include precursor information about a similar event. Based on statistical patterns of information stored in the TPM, the systems then generates predictions about other events, and displays information about the predictions on a display device. Note that while TPMs can be used to predict an event that might take place in the future, TPMs can also be used to make predictions about events that have actually taken place, so that the accuracy of the TPMs' predictions can be assessed, and the model adjusted if needed, as described in greater detail below.

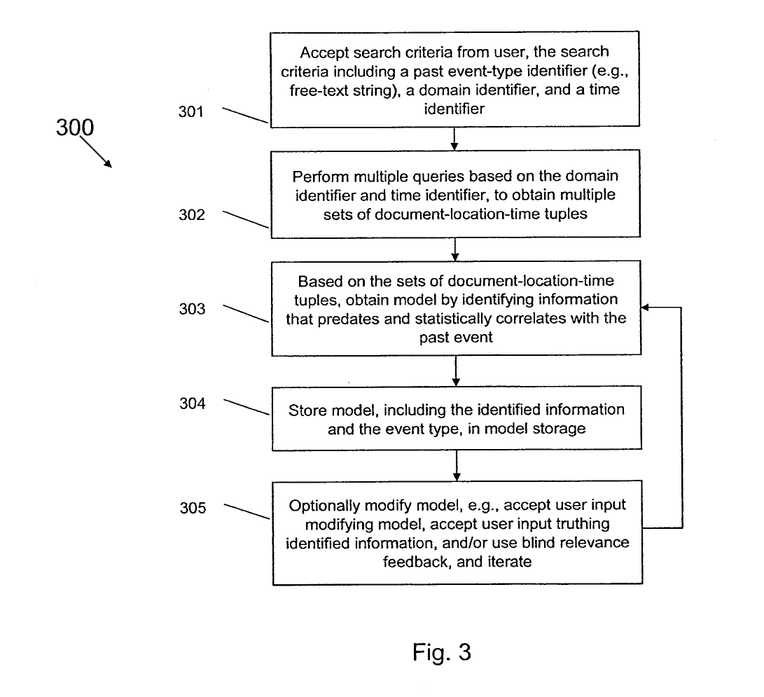

FIG. 3 illustrates a method 300 for using a TPM in training mode, e.g., to identify and store precursor information associated with a known past event. First, the system accepts search criteria from a user that identifies the past event (301), e.g., using the interface 80 illustrated in FIG. 2. The search criteria includes a domain identifier identifying a domain in which the known past event at least partially occurred, an event-type identifier identifying the type of event (e.g., a free-text string, selection from a drop-down menu, or other appropriate way of identifying the event type), and a time identifier that identifies a time period, typically some amount of time prior to the event's occurrence. The domain identifier can be a bounding box in the map area 805, which the user positions over a domain of interest. For example, a user training the system to anticipate Ebola outbreaks could identify a geographic extent and time range for at least one past outbreak, and enter the text string “Ebola outbreak.”

Optionally, the user can identify multiple events. For example, if multiple outbreaks occurred at once, there might be multiple bounding boxes on the same day. For different days of the outbreaks, the user can identify different domains, e.g., can increase or decrease the size of the bounding box, or add or delete new bounding boxes, to select appropriate documents.

Next, the system performs multiple queries based on the domain identifier and time period in the user's search criteria (302). Note that not all queries need use the user's free-text string identifying the type of event, because not all documents relevant to an event include the event name. For example, a hospital admission record dating to the beginning of an Ebola outbreak will likely not include the string “Ebola,” because the outbreak has not yet been identified, and the infection may not have been diagnosed. To perform the queries, the system searches the pre-processed corpus of document-location-time tuples in storage 22. For example, a TPM for anticipating Ebola outbreaks in Africa might use documents from web sites and news wires about Africa.

Specifically, the system performs four queries:

| | Target | Background |
|---|---|---|
| In | An In-Target (IT) query uses the | An In-Background (IB) query |
| | domain identifier and time period from | uses the same time range as the IT |
| | the user's query as filters to find | query. However, instead of using the |
| | document-location-time tuples that | same domain identifier, the IB uses a |
| | refer to locations within the extent and | global extent query minus the domain |
| | to times within the range. Since these | identified in the IT query. This query |
| | document-location-time tuples relate | retrieves documents that are from the |
| | both geographically and temporally to | same time period as the IT query, but |
| | the past event identified by the user's | from a different domain. |
| | query, they have a high probability of | |
| | relating topically as well. | |
| Pre | A Pre-Target (PT) query uses | A Pre-Background (PB) query |
| | the same domain identifier as the IT | is uses the same time period as the PT |
| | query, and a time period preceding the | query and the same domain as the IB |
| | time period used in the IT query. | query. PB queries help to remove |
| | Typically, a PT query's time range will | irrelevant noise that happened to |
| | extend for as long a period of time | emerge in the same time period. |
| | before the IT query as the duration of | |
| | the IT query's time range, although | |
| | other time ranges can be used. | |

The system constructs an IT-IB pair of queries and a set of PT-PB pairs for a time period before the IT-IB time period. The number of PT-PB pairs is an adjustable parameter that the user can set. The user can instruct the system to execute multiple PT-PB queries using a variety of time periods in order to enhance the predictive power of the model. Based on the queries, the system obtains multiple sets of document-location-time tuples from storage 22.

The same conceptual distinction between IT, IB, PT, and PB queries also applies to non-document data sources, as long as there is metadata giving place and time coordinates. For example, a stock trade has information about where and when the trade took place. The following discussion focuses on describes the development of TPMs using documents, however it should be understood that other types of information are susceptible to the same types of treatment.

Next, based on the sets of document-location-time tuples obtained in the queries, the system creates a model by identifying precursor information (303), i.e., by identifying information that predates and statistically correlates to the past event. Specifically, the system uses a Reference Corpus (RC) of n-grams to detect interesting phrases. The RC is constructed to reflect language and genre typical of the documents used in the system. Typically, the entire body of documents available to the system is used as an RC, but reference corpora can extend to documents not enrolled in the system.

For each set of document-location-time tuples (e.g., for the sets obtained from the IT, PT, IB, and PB queries), the system processes the full text of every document matching the query and obtains “Statistically Interesting Phrases” (SIPs). The system obtains SIPs using the following steps:
1. Extract all n-grams from the document-location-time tuple, i.e. all strings of n words, for n=1, 2, 3, 4, 5
2. Compute the N-Gram Estimate of Random Occurrence (NGERO) for each extracted n-gram by taking the ratio of the frequency of the n-gram in the document-location-time tuple to the frequency of the n-gram in the RC. When the latter number is zero, standard smoothing techniques are used.
3. Sort the n-grams on their NGERO and consider only those n-grams with NGERO higher than a threshold value—this value is an adjustable parameter, e.g., that the user may have the option to set. The n-grams above the threshold value are defined to be SIPs.

For each SIP obtained from an IT query, the system computes a Geographic Indicator Score by determining the ratio of the number of occurrences of the SIP in the IT query to the number of occurrences of the SIP in the document-location-time tuple obtained from the corresponding IB query. For each SIP obtained from a PT query, the system computes another Geographic Indicator Score by determining the ratio of the number of occurrences of the SIP in the PT query to the number of occurrences of the SIP in the document-location-time tuple obtained from the corresponding PB query.

The system then sorts the SIPs by Geographic Indicator Score, and considers only those above a threshold value. These SIPs are defined to be both rare in general and rare for the specific time of the query. A SIP might be rare in general but not rare for the specific time of the query, because some global event pushed the phrase into common occurrence everywhere, not just in association with the target event. These special SIPs are strongly correlated with the past event identified in the user's query are called Target-Associated SIP (TASIPs)

Those TASIPs that appear before the actual start of the event, i.e., those that occur primarily in the PT queries, are the ones useful for prediction. To isolate these special TASIPs, the system (in training mode) obtains a Temporal Indicator Score by determining the ratio of the number of occurrences of each TASIP in document-location-time tuples from the PT query to the number of occurrences of the TASIP in document-location-time tuples from the corresponding IT query. These ratios establish the temporal prescience of a TASIP by comparing across time instead of across geography.

The trainer sorts the TASIPs using the Temporal Indicator Score and considers only those above a given threshold (which may be under the control of the user). These TASIPs are called Pre-Event Target Associated SIPs (PETASIPs).

The system uses the list of PETASIPs as a TPM for the event type, and stores the list of PETASIPs in model storage (304). Optionally, the list of PETASIPs is labeled with a name indicating the type of event for which the list of PETASIPs is predictive. Similar pre-event target-associated indicators (PETAIs) can be derived for non-textual information sources using the same logic, i.e., using the same notions of target, spatial, and temporal specificity.

As described in greater detail below, the TPM can be used in prediction mode by issuing the PETASIPs and/or PETAIs as match criteria (queries) against a corpus of information.

Optionally, the model is modified, e.g., to refine the list of PETASIPs. At this point (305), the system can allow the user to produce relevance feedback for the documents (e.g., by allowing the user to rank the documents on a Quality of Prediction (QP) scale of 1-10); allow the user to provide truth (e.g., by selecting the documents that are truly indicative of the event, corresponding to a QP scale of 0-1); or the user can direct the system to perform refinement based on blind relevance feedback (corresponding to an implicit QP scale).

In the refinement loop 303-305, the system in training mode performs new sets of IT/IB and PT/PB queries on high QP-scored events and adds the resulting PETASIPs (or PETAIs) to its list. The trainer also performs IT/IB and PT/PB queries on non-high-QP-scoring predictions and also extracts PETASIPs. These PETASIPs are associated with a new category of event designated as Non-Goal-Events (NGEs). Whenever a PETASIP query finds a possible event, the system looks for NGE PETASIPs in the resulting documents and computes a ratio called the Goal Event Ratio (GER) by constructing the ratio of event PETASIPs to NGE PETASIPs in the documents.

The GER allows the system to assess the likelihood that a possible event will be scored by the user as low QP. The system can present these documents to the user with an indication of their GER. If the model successful identifies a useful document, then the user will likely agree with the GER score. If not, then the user can see that the system misidentified a document by giving it an inappropriately high GER. Often, such a document will be a good training document. By submitting such a document to the model as a false positive, system can remove or demote the importance of PETASIPs that occur in that document.

The user can also directly control various aspects of the TPM, e.g., by editing the PETASIPs, or by adding or removing components of the query that they feel will improve the quality of the predictions.

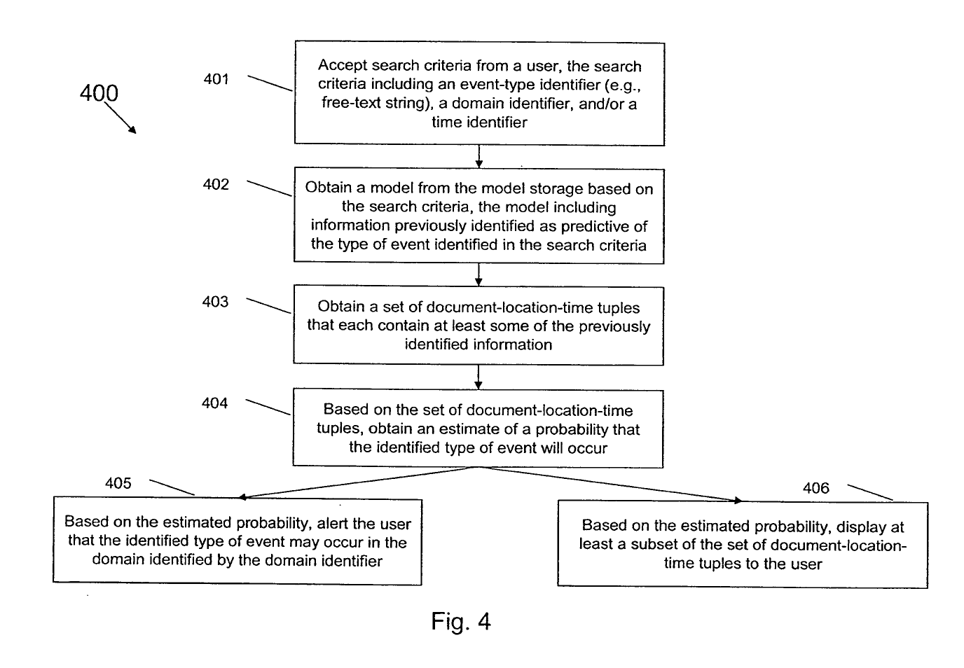

FIG. 4 illustrates a method 400 of using a TPM to estimate a probability of a particular type of event occurring. First, the system accepts search criteria from a user (401). The search criteria includes an event type identifier identifying the type of event the user would like to predict, a domain identifier identifying a domain of interest, and a time identifier identifying a time period of interest, e.g., a period of time leading up to the time of the user's search. The event type identifier can be in the form of a free-text string, selection from a drop-down menu, or some other form of identifying the event type.

The system obtains a model (TPM) from the model storage based on the user query (402). Typically, TPMs are stored with information that identifies the type of event for which it is predictive, and the system selects a relevant TPM based on this information. As described above, the TPM includes PETASIPs and/or PETAIs, i.e., information that has previously been identified as predictive of the type of event identified in the user query.

The system also obtains a set of document-location-time tuples that each contain at least some of the information that has previously been identified as predictive of the type of event identified in the user query (403). For example, the system first filters the document-location-time tuples in the corpus based on the domain identifier and the time identifier in the user query; and then executes one or more searches using the PETASIPS and/or PETAIs as queries, thus identifying a set of document-location-time tuples, each of which includes at least some of the previously identified predictive information.

Then, based on the set of document-location-time tuples, the system obtains an estimate of a probability that the identified type of event will occur (404). For example, whenever a PETASIP query finds a possible event, the system looks for NGE PETASIPs in the resulting documents and computes a ratio called the Goal Event Ratio (GER) by constructing the ratio of event PETASIPs to NGE PETASIPs in the documents. If the GER is above a threshold chosen by the user, the prediction generates a warning. These GERs are used to estimate the probability that the identified type of event will occur.

Based on the estimated probability, the system then alerts the user that the identified type of event may occur (405) and/or displays at least a subset of the document-location-time tuples to the user (406). Displaying the tuples to the user can be useful because it allows the user to examine the documents and evaluate the chance of the event occurring.

As a further example, the system may issue searches without any spatial or temporal constraints and with text strings constructed from PETASIPs or PETAIs associated with a particular event. By analyzing the returned results, the system may identify locations or time periods in which similar events have occurred. For example, a PETASIP associated with ship docking events might be “entering harbor at XXX” where XXX denotes a time reference. Any document containing the phrase “entering harbor at” followed by a time reference is thus a candidate result for a query constructed from this PETASIP. In the list of document identifiers returned for this query, the system may detect that some of the documents contain other PETASIPs associated with this model. These documents are thus more likely to indicate a ship docking event. The locations and times indicated in these documents are candidates for ship docking locations and times. For a user interested in ship dockings, these candidate location-time tuples are valuable. By displaying these location-time tuples to the user in a visual display, the system can accelerate the user's work.

The system allows users to iteratively update the information in the model by submitting new training documents and by modifying the PETASIPs and PETAIs directly. As these updates are incorporated into the model, subsequent attempts at predictions are generally improved.

A number of embodiments of the invention have been described. Nevertheless, it will be understood that various modifications may be made without departing from the spirit and scope of the invention. Accordingly, other embodiments are within the scope of the following claims.

What is claimed is:

1. A computer-implemented method of generating a predictive model, the method comprising:
accepting search criteria from a user, the search criteria including information identifying a past event, a domain identifier identifying a domain in which the past event occurred, and a time identifier identifying a time period preceding the past event;
obtaining a plurality of sets of document-location-time tuples based on the domain identifier and the time identifier;
statistically analyzing the sets of document-location-time tuples;
comparing results of the statistical analysis of the sets of document-location-time tuples to identify information that precedes and statistically correlates with the past event; and
displaying information associated with the identified information on a display device.

2. The method of claim 1, further comprising labeling the identified information according to an event type, and storing the labeled identified information on a computer-readable medium.

3. The method of claim 1, wherein obtaining the plurality of sets of document-location-time tuples comprises obtaining a first set of tuples that includes information about the domain, and obtaining a second set of tuples that includes information about a region that excludes the domain.

4. The method of claim 1, wherein obtaining a plurality of sets of document-location-time tuples comprises obtaining a first set of tuples that includes information about a time period preceding the past event, and obtaining a second set of tuples that includes information about a time period that excludes the time period preceding the past event.

5. The method of claim 1, further comprising automatically refining the identified information based on at least some document-location-time tuples in response to user input.

6. The method of claim 5, wherein said refining comprises at least one of accepting user input scoring at least some of the document-location-time tuples and entering a feedback loop; accepting user input truthing at least some of the document-location-time tuples and entering a feedback loop; using blind relevance feedback in response to a user instruction; and accepting user input modifying the identified information.

7. The method of claim 1, wherein the information associated with the identified information comprises a model of an event of the same type as the past event.

8. The method of claim 1, wherein the information associated with the identified information comprises an abstraction of the identified information.

9. The method of claim 1, wherein the identified information comprises at least one of a statistically interesting phrase and statistically interesting information.

10. An interface program stored on a computer-readable medium for causing a computer system with a display device to perform the functions of:
accepting search criteria from a user, the search criteria including information identifying a past event, a domain identifier identifying a domain in which the past event occurred, and a time identifier identifying a time period preceding the past event;
obtaining a plurality of sets of document-location-time tuples based on the domain identifier and the time identifier;
statistically analyzing the sets of document-location-time tuples;
comparing results of the statistical analysis of the sets of document-location-time tuples to identify information that precedes and statistically correlates with the past event; and
displaying information associated with the identified information on a display device.

11. The interface program of claim 10, wherein the program further causes the computer system to perform the functions of labeling the identified information according to an event type, and storing the labeled identified information on a computer-readable medium.

12. The interface program of claim 10, wherein obtaining the plurality of sets of document-location-time tuples comprises obtaining a first set of tuples that includes information about the domain, and obtaining a second set of tuples that includes information about a region that excludes the domain.

13. The interface program of claim 10, wherein obtaining a plurality of sets of document-location-time tuples comprises obtaining a first set of tuples that includes information about a time period preceding the past event, and obtaining a second set of tuples that includes information about a time period that excludes the time period preceding the past event.

14. The interface program of claim 10, wherein the program further causes the computer system to perform the functions of automatically refining the identified information based on at least some document-location-time tuples in response to user input.

15. The interface program of claim 10, wherein said refining comprises at least one of accepting user input scoring at least some of the document-location-time tuples and entering a feedback loop; accepting user input truthing at least some of the document-location-time tuples and entering a feedback loop; using blind relevance feedback in response to a user instruction; and accepting user input modifying the identified information.

16. The interface program of claim 10, wherein the information associated with the identified information comprises a model of an event of the same type as the past event.

17. The interface program of claim 10, wherein the information associated with the identified information comprises an abstraction of the identified information.

18. The interface program of claim 10, wherein the identified information comprises at least one of a statistically interesting phrase and statistically interesting information.

19. A computer-implemented method of using a model to predict an event, the method comprising:
accepting search criteria from a user, the search criteria including information identifying a type of event the user would like to predict, a domain identifier identifying a domain, and a time identifier identifying a time period;
obtaining a model based on the type of event the user would like to predict, the model including information that was previously identified as being predictive of the type of event;
obtaining a set of document-location-time tuples based on the domain identifier and the time identifier, each of the document-location-time tuples including at least some of the information that was previously identified as being predictive of the type of event;
based on the set of document-location-time tuples, estimating a probability that the type of event will occur in the domain; and
if the estimate of the probability exceeds a predefined threshold, alerting the user.

20. The method of claim 19, wherein alerting the user comprises at least one of displaying information about the estimated probability of the event to the user; emailing a notification to the user; displaying a visual representation of the domain identified by the domain identifier; and displaying at least one of the document-location-time-tuples to the user.

21. The method of claim 19, further comprising providing an interface allowing a user to request additional information related to the estimate of the probability.

22. The method of claim 21, wherein the request for additional information includes a free text query string, and wherein the method further comprises displaying to the user a visual representation of locations identified in document-location-time tuples responsive to the free text query.

23. The method of claim 21, wherein the request for additional information includes a spatial domain identifier identifying a domain, and wherein the method further comprises displaying to the user a visual representation of the identified domain and a listing of documents containing spatial identifiers that identify locations within the domain.

24. The method of claim 19, further comprising providing an interface for the user to modify the model.

25. The method of claim 24, wherein the interface allows the user to provide a set of training document-location-time tuples that include information about the type of event.

26. An interface program stored on a computer-readable medium for causing a computer system with a display device to perform the functions of:
accepting search criteria from a user, the search criteria including information identifying a type of event the user would like to predict, a domain identifier identifying a domain, and a time identifier identifying a time period;
obtaining a model based on the type of event the user would like to predict, the model including information that was previously identified as being predictive of the type of event;
obtaining a set of document-location-time tuples based on the domain identifier and the time identifier, each of the document-location-time tuples including at least some of the information that was previously identified as being predictive of the type of event;
based on the set of document-location-time tuples, estimating a probability that the type of event will occur in the domain; and
if the estimate of the probability exceeds a predefined threshold, alerting the user on a display device.

27. The interface program of claim 26, wherein alerting the user comprises at least one of displaying information about the estimated probability of the event to the user on the display device; emailing a notification to the user; displaying a visual representation of the domain identified by the domain identifier on the display device; and displaying at least one of the document-location-time-tuples to the user on the display device.

28. The interface program of claim 26, wherein the program further causes the computer system to perform the functions of providing an interface allowing a user to request additional information related to the estimate of the probability.

29. The interface program of claim 28, wherein the request for additional information includes a free text query string, and wherein the program further causes the computer system to perform the functions of displaying to the user a visual representation of locations identified in document-location-time tuples responsive to the free text query.

30. The interface program of claim 28, wherein the request for additional information includes a spatial domain identifier identifying a domain, and wherein the program further causes the computer system to perform the functions of displaying to the user a visual representation of the identified domain and a listing of documents containing spatial identifiers that identify locations within the domain.

31. The interface program of claim 26, wherein the program further causes the computer system to perform the functions of providing an interface for the user to modify the model.

32. The interface program of claim 31, wherein the interface allows the user to provide a set of training document-location-time tuples that include information about the type of event.
